(19) United States
(12) Patent Application Publication
(10) Pub. No.: US 2006/0211397 A1
(43) Pub. Date: Sep. 21, 2006

(54) Analogue mixer

(76) Inventor: John B. Hughes, Hove (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/515,156

(22) PCT Filed: May 15, 2003
(86) PCT No.: PCT/IB03/02067

§ 371 Date: Nov. 19, 2004

(30) Foreign Application Priority Data
May 24, 2002 (GB) 0212000.4

(51) Int. Cl. H04B 1/26

(52) U.S. Cl. 455/323

(57) ABSTRACT

A mixer suitable for implementation in low voltage, low power CMOS employs a class AB transconductor to achieve analogue multiplication through simultaneous modulation of both the transconductor input and its internal voltage rail.

The invention relates to a mixer suitable for use in a wireless receiver or transceiver, a wireless receiver or transceiver comprising a mixer, and an integrated circuit comprising a mixer.

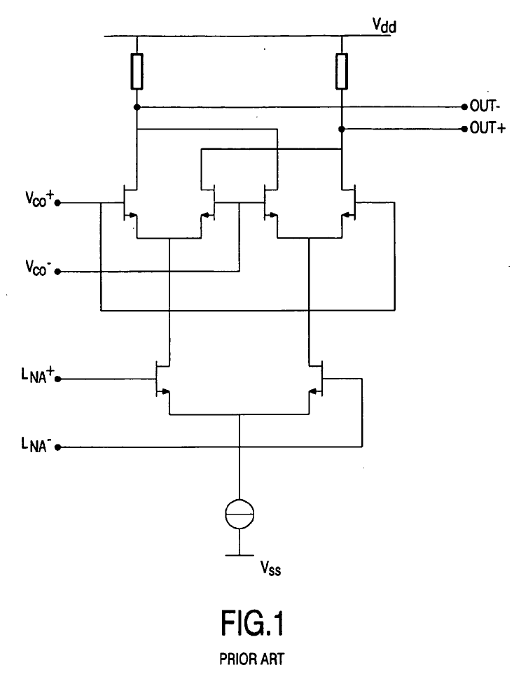

The wireless transceiver industry is currently attempting to drive down cost and power consumption by attempting standard CMOS solutions for wireless networking applications such as Bluetooth and ZigBee. An important contributor to power consumption is the polyphase mixer which down-converts RF signals to zero- or low-IF. Known mixer circuit configurations are based on the Gilbert multiplier shown in FIG. 1. Examples of such mixers are disclosed in “Analysis and Design of Analog Integrated Circuits”, P. R. Gray, R. G. Meyer, John Wiley and Sons, pp. 593-600 and in “Implementation of a CMOS LNA Plus Mixer for GPS Applications with No External Components”, IEEE Trans Very Large Scale Integration (VLSI) Systems, Vol. 9, No. 1, Feb, 2001, pp. 100-104. In FIG. 1 the lower long-tail pair acts as a class A transconductor which converts the input voltage from a low noise amplifier (LNA) into a current. The upper tier of transistors is driven by a VCO signal between their cut-off and triode regions, i.e. they behave as change-over switches, and periodically reverse the current from the lower tier. The output signal may be taken directly as a current or as a voltage on resistive loads.

The circuit of FIG. 1 has several drawbacks when used in a low power, low voltage situation. First, the circuit operates in class A (the output current must be less than half of the tail current) and this results in high power consumption. Secondly, the stack of transistors requires significant voltage headroom which may be excessive with the ever diminishing power supply voltages of digital CMOS IC's. Thirdly, the output is close to the V_{dd} supply and this can make interfacing to a following channel filter quite difficult because the much lower frequencies require large capacitors for AC coupling. Alternative level shifters employing MOSTs dissipate more power and create extra noise. When the circuit technique for the channel filter connected to the mixer output uses class AB transconductors for low power consumption, this interfacing is particularly difficult because the quiescent input voltage is usually around mid-rail.

An object of the present invention is to provide an improved mixer.

According to a first aspect of the invention there is provided a mixer comprising a class AB transconductor and means to modulate simultaneously an input of the transconductor with a first signal and a power rail of the transconductor with a second signal.

According to a second aspect of the invention there is provided a wireless receiver comprising a mixer in accordance with the first aspect of the invention.

According to a third aspect of the invention there is provided a wireless transceiver comprising a mixer in accordance with the first aspect of the invention.

According to a fourth aspect of the invention there is provided an integrated circuit comprising a mixer in accordance with the first aspect of the invention.

The class AB operation of the transconductor allows a reduction of power consumption and low voltage operation.

The invention will now be described, by way of example only, with reference to the accompanying drawings wherein:

FIG. 1 is a schematic diagram of a prior art mixer,

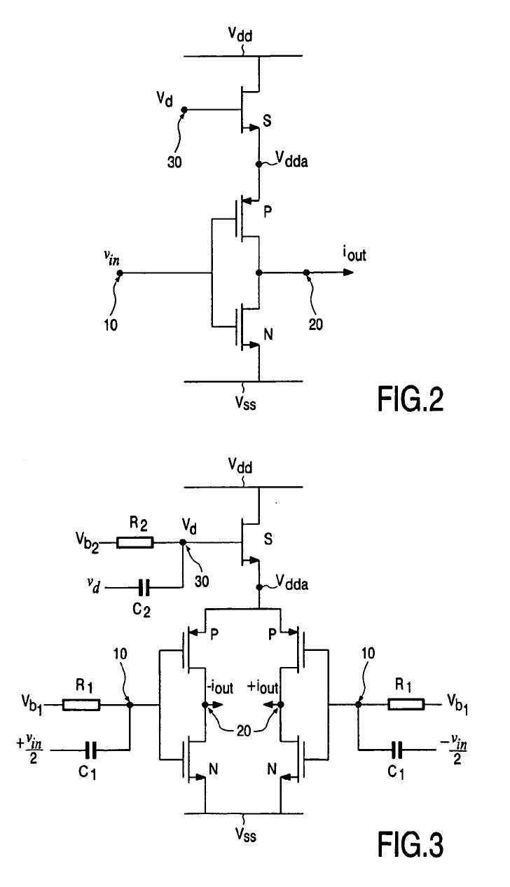

FIG. 2 is a schematic diagram of a mixer in accordance with the invention,

FIG. 3 is a schematic diagram of a balanced mixer in accordance with the invention,

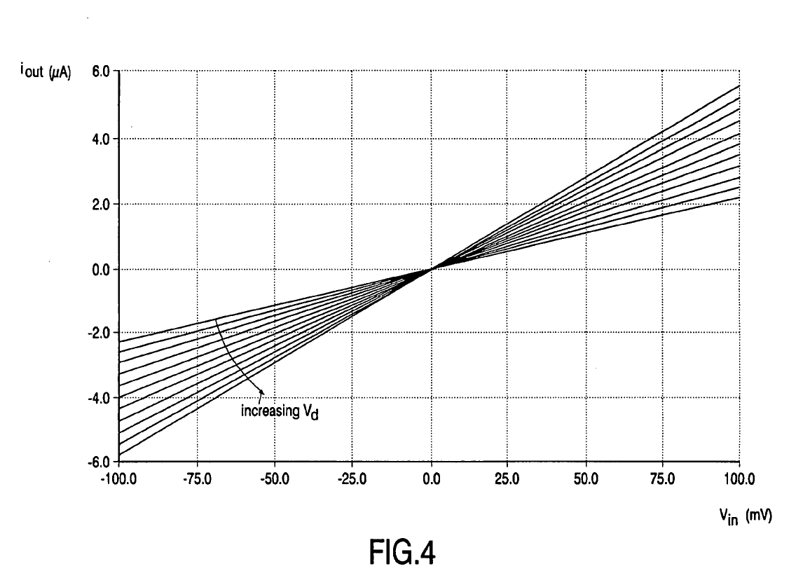

FIG. 4 is a graph showing output characteristics for a range of DC input signals,

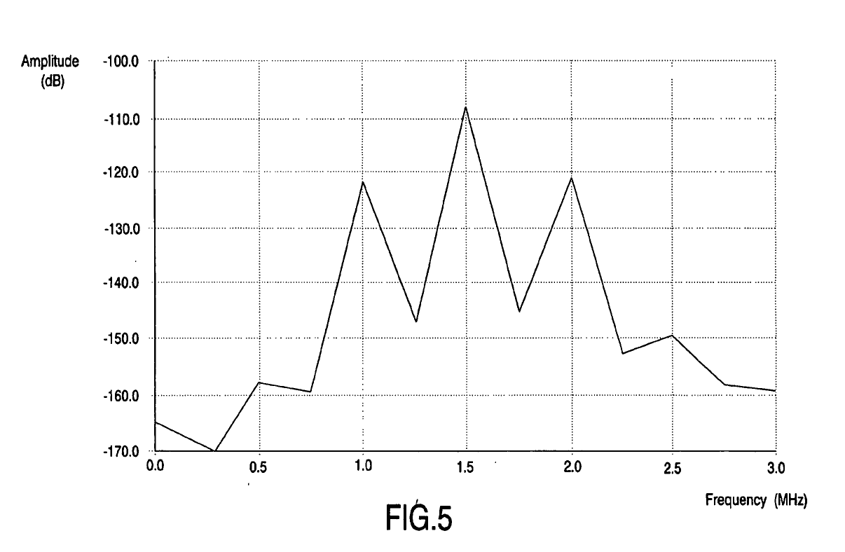

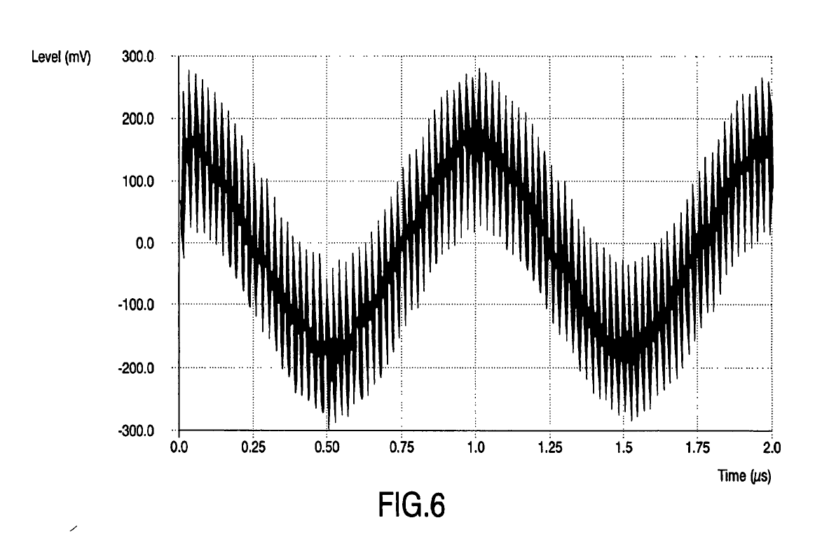

FIG. 5 is graph showing the Fourier transform of an output current for low frequency sinusoidal input signals,

FIG. 6 is a plot of an output signal for high frequency sinusoidal input signals, and

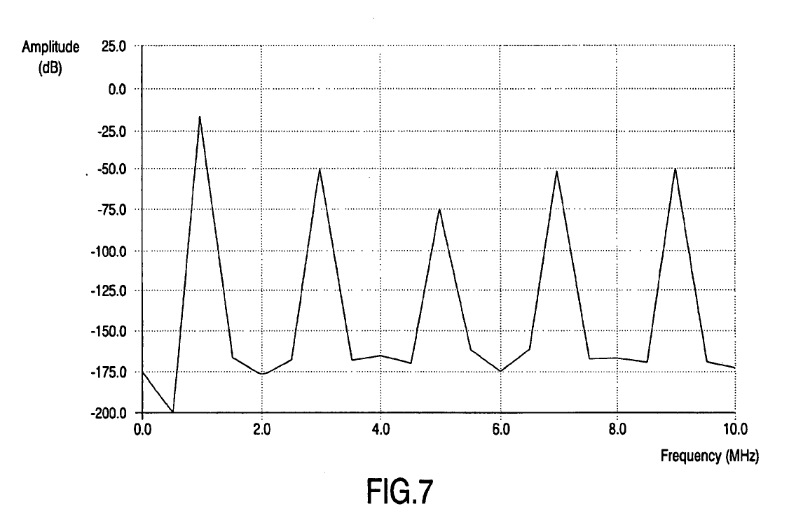

FIG. 7 is a graph showing the Fourier transform of an output current for high frequency sinusoidal input signals.

Referring to FIG. 2, there is a mixer comprising a class AB transconductor having transistors P and N coupled at their gates to provide an input node 10, coupled at their drains to provide an output node 20, and with the sources of the P and N transistors coupled to respective voltage rails Vₛₛ and V_{dda}. The class AB transconductor has a transconductance Gₘ=gₘₚ+gₘₙ which depends on its bias current and can be controlled by the value of the rail voltage V_{dda}. gₘₚ and gₘₙ are the transconductances of the transistors P and N respectively. A source follower transistor S is coupled between the voltage rail V_{dda} and a voltage rail V_{dd}. The drain voltage V_{d} of the source follower S at node 30 is controlled to create the desired value of Gₘ. This control may be applied by means of a known charge-pump bias control circuit to establish the mean level of V_{d}. For equal transistor parameters (a simplifying but non-essential condition), the quiescent input voltage at the input node 10 which produces no output current at the output node 20 is at V_{dda/2}. The value of the transconductance of the transconductor can be expressed as follows. With the transistors P, N in saturation, the drain-source current may be described by the square-law equation:
I_{ds}=kV_{gt}² (1)
where k=μCₒₓ W/(2L) and V_{gt}=V_{gs}−Vₜ where μ is the mobility, Cₒₓ is the specific gate oxide capacitance, W is the channel width, L is the channel length, V_{gs} is the gate-source voltage and Vₜ is the gate threshold voltage. The transconductance is given by:

$${G}_{m} = {g}_{mp} + {g}_{mn} = 2 {kV}_{gt} = 2 k ( \frac{{V}_{data}}{2} - {V}_{t} ) \qquad ( 2 )$$

from which it can be seen that Gₘ is proportional to the value of V_{dda}. When an input signal νᵢₙ is applied to the input node 10, and the value of V_{dda} is modulated by a signal μ_{d} at node 30, then Gₘ is also modulated:

$${G}_{m} ( v ) = 2 k ( \frac{{V}_{dda} + {v}_{d}}{2} - {V}_{t} ) \qquad ( 3 )$$

and the output current is given by:

$$\begin{matrix}{i}_{out} = {G}_{m} ( v ) \cdot {v}_{in} \\ = 2 {kv}_{in} ( \frac{{V}_{dda} + {v}_{d}}{2} - {V}_{t} ) \\ = {G}_{m} {v}_{in} + {kv}_{in} {v}_{d}\end{matrix} \qquad ( 4 )$$

In equation (4) the output current iₒᵤₜ has a first term which is proportional to νᵢₙ and a second term which is proportional to the product of νᵢₙ and ν_{d}.

FIG. 3 is a schematic diagram of a balanced mixer comprising two of the transconductors shown in FIG. 2, both coupled between the voltage rails V_{dda} and Vₛₛ. In FIG. 3, V_{b1} and V_{b2} are bias voltages applied to respectively nodes 10 and 30 by means of resistors R₁ and R₂. A differential input voltage ±νᵢₙ/2 is applied to the input nodes 10 by means of AC coupling capacitors C₁. The results shown in FIGS. 4 to 7 have been obtained from a simulation of the mixer illustrated in FIG. 3.

FIG. 4 is a graph showing how the output current iₒᵤₜ at output nodes 20 varies with a DC input voltage νᵢₙ for values of the gate voltage V_{d} of the source follower S ranging from −250 mV to +250 mV in steps of 50 mV. It can be seen from FIG. 4 that the DC performance is linear.

Setting νᵢₙ and ν_{d} to be sinusoids so that
νᵢₙ=νᵢₙₚₑₐₖ sin (ω₁t) and ν_{d}=ν_{dpeak} sin (ω₂t)
equation (4) becomes:

$$\begin{matrix}{i}_{out} = {G}_{m} {v}_{inpeak} sin ( {ω}_{1} t ) + {kv}_{inpeak} sin ( {ω}_{1} t ) {v}_{dpeak} sin ( {ω}_{2} t ) \\ = {I}_{1} sin ( {ω}_{1} t ) + {I}_{2} ( cos ( {ω}_{1} + {ω}_{2} ) t - cos ( {ω}_{1} - {ω}_{2} ) t )\end{matrix} \qquad ( 5 )$$

The presence of the sum and difference frequencies in equation (5) demonstrates the mixing function of the circuit.

FIG. 5 is graph showing the Fourier transform of the output current iₒᵤₜ when νᵢₙ is set to 1.5 MHz and ν_{d} is set to 0.5 MHz. The presence of output signal components at 1.5 MHz, 2 MHz and 1 MHz, corresponding to the three terms of equation (5) is clearly apparent.

FIG. 6 is a plot of the output current iₒᵤₜ monitored on resistive loads when νᵢₙ is set to 1 GHz and ν_{d} is set to 1.001 GHz, and FIG. 7 is a plot showing the Fourier transform of the output current iₒᵤₜ under the same conditions. Ideally such conditions would produce components at 1 GHz, 1 MHz and 2.001 GHz. FIGS. 6 and 7 exhibit a component at 1 MHz and a set of all odd harmonics resulting from extra high frequency distortion. This is normal for RF mixers.

When the mixer is used in a wireless receiver, or the receiver stage of a wireless transceiver, the input voltage νᵢₙ is the received signal supplied by a low noise amplifier (LNA) and the voltage ν_{d} is a local oscillator signal supplied by, for example, a voltage controlled oscillator (VCO). Alternatively, the LNA and VCO may be coupled to supply ν_{d} and νᵢₙ respectively.

The voltages from the LNA and VCO may be AC coupled to the mixer inputs because they are at a very high frequency. AC coupling is illustrated in FIG. 3 by means of capacitors C₁ and C₂.

The low frequency output current iₒᵤₜ may be directly coupled to the input terminating transconductors of a channel filter following the mixer thereby obviating the need for large coupling capacitors.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the art of CMOS circuits and the art of wireless transceivers and which may be used instead of or in addition to features already described herein.

1. A mixer (100) comprising a class AB transconductor (P, N) and means (10, 30) to modulate simultaneously an input (10) of the transconductor with a first signal (νᵢₙ) and a voltage rail (V_{dda}) of the transconductor with a second signal (ν_{d}).

2. A wireless receiver comprising a mixer as claimed in claim 1.

3. A wireless transceiver comprising a mixer as claimed in claim 1.

4. An integrated circuit comprising a mixer as claimed in claim 1.
